(19) United States
(12) Patent Application Publication
(10) Pub. No.: US 2011/0001671 A1
(43) Pub. Date: Jan. 6, 2011

(54) MOBILE COMMUNICATION TERMINAL

(75) Inventor: Yusuke Miura, Tokyo (JP)

Correspondence Address: HOLTZ, HOLTZ, GOODMAN & CHICK PC, 220 Fifth Avenue, 16TH Floor, NEW YORK, NY, 10001-7708, US

(73) Assignee: KABUSHIKI KAISHA TOSHIBA, TOKYO (JP)

(21) Appl. No.: 12/715,643

(22) Filed: Mar. 2, 2010

(30) Foreign Application Priority Data
Jul. 2, 2009 (JP) 2009-157860

(51) Int. Cl. H01Q 1/24

(52) U.S. Cl. 343/702

(57) ABSTRACT

A mobile communication terminal having a first housing section and a second housing section is provided. The first housing section includes a metallic portion. The second housing section is movably coupled to the first housing section. The second housing section is provided with an antenna. The second housing section is provided with a conductive element which covers a portion of the antenna from the metallic portion regardless of a position of the second housing section relative to the first housing section. The conductive element is electrically open.

### CROSS REFERENCE TO RELATED APPLICATIONS

This application is based upon and claims the benefit of priority from the prior Japanese Patent Application No. 2009-157860 filed on Jul. 2, 2009; the entire contents of which are incorporated herein by reference.

### BACKGROUND OF THE INVENTION

1. Field of the Invention

The present invention relates to a mobile communication terminal that can be deformed into a plurality of shapes, and can reduce a change of impedance of an antenna by being provided with a conductive element close to the antenna.

2. Description of the Related Art

Mobile communication devices such as mobile phones have come into wide use in recent years. Various types of mobile communication devices have been proposed and developed, such as a mobile communication device having upper and lower housing sections which are coupled to each other through a two-axis hinge portion provided in a supporting material. To put it specifically, the upper and lower housing sections of the mobile communication device can be open and closed to each other in a BC-face direction around a horizontal hinge axis provided in a direction of the width at an upper end of the lower housing section. Further, the upper housing section can rotate with respect to the lower housing section around a vertical hinge axis provided in the supporting material in the middle of the upper end of the lower housing section.

For such a mobile communication device that can be deformed into a plurality of shapes, a metallic first hinge axis provided in the upper housing section quite supposedly has an electric length which can be resonant with a wavelength in a used frequency range. Thus, there is a problem in that an effect of the hinge portion on the antenna cannot be disregarded.

Thus, a mobile communication device of a type having housing sections of a bidirectional open/close system such that the effect of the hinge portion on the antenna can be effectively reduced is known, e.g., as disclosed in Japanese Patent Publication of Unexamined Application (Kokai), No. 2009-111895.

The mobile communication device of JP-A-2009-111895 has a horizontal hinge portion which movably connects an upper housing section and a hinge housing section around a first axis core. The horizontal hinge portion is constituted by a horizontal hinge ankle, a horizontal hinge plate and a first hinge axis. The horizontal hinge ankle is electrically connected to a first metallic portion provided in the upper housing section 1. The horizontal hinge plate is provided in the hinge housing section and includes a conductive material. The first hinge axis electrically connects the horizontal hinge ankle and the horizontal hinge plate, and includes a conductive material provided between almost the middle point of a longer side of a face on which the upper housing section and the hinge housing section face to each other in a direction of a second axis core and an end portion. Further, an electric path length of the horizontal hinge portion which is a sum of the lengths of the horizontal hinge plate and the first hinge axis is a certain value except for a multiple of approximately one-eighth of the wavelength.

A growing trend in a mobile phone having upper and lower housing sections which are coupled to each other through a hinge portion provided in a supporting material is to have a housing internal case formed by metal (such as magnesium) or a metallic material is provided in the housing internal case from a viewpoint of mechanical strength of a display or from an aesthetic viewpoint. Meanwhile, if a lower housing hinge portion is provided with an antenna, the antenna is close to a metallic material provided in an upper housing internal case. As the position of the metallic material relative to the antenna changes depending upon whether the mobile phone 1 is in open or closed states, a resonant frequency of the antenna significantly changes. There is a problem in that, if antenna impedance significantly changes owing to a change between the open and closed states and the impedance is matched in the one state, the antenna performance is degraded in the other state.

### SUMMARY OF THE INVENTION

Accordingly, an advantage of the present invention is to provide a mobile communication device that can be deformed into a plurality of shapes (e.g., open and closed states), can reduce a change of antenna impedance even if provided with something metallic close to the antenna, and can implement an antenna configuration resisting metallic conditions more than usual.

To achieve the above advantage, one aspect of the present invention is that a mobile communication terminal having a first housing section and a second housing section is provided. The first housing section includes a metallic portion. The second housing section is movably coupled to the first housing section. The second housing section is provided with an antenna. The second housing section is provided with a conductive element which covers a portion of the antenna from the metallic portion regardless of a position of the second housing section relative to the first housing section. The conductive element is electrically open.

### BRIEF DESCRIPTION OF THE DRAWINGS

FIG. 1A is a front view of a mobile communication terminal (mobile phone) of the present invention being open.

FIG. 1B is a side view of the mobile communication terminal (mobile phone) of the present invention being open.

FIG. 2A is a front view of the mobile communication terminal (mobile phone) of the present invention being closed.

FIG. 2B is a side view of the mobile communication terminal (mobile phone) of the present invention being closed.

FIG. 3 is a schematic diagram showing an antenna provided in an interface portion between upper and lower housing sections of the mobile communication terminal (mobile phone) of the present invention.

FIG. 4A is a schematic side view diagram showing an example of a position of an antenna mounting portion relative to a metallic member in an open state of the mobile communication terminal (mobile phone) of the present invention having no conductive element.

FIG. 4B is a schematic side view diagram showing an example of a position of the antenna mounting portion relative to the metallic member in a closed state of the mobile communication terminal (mobile phone) of the present invention having no conductive element.

FIG. 5 shows impedance characteristics in the open and closed states of the mobile communication terminal (mobile phone) of the present invention having no conductive element on a same graph.

FIG. 6 is a schematic diagram showing the interface portion between the upper and lower housing sections provided with the antenna and a conductive element in the open state of the mobile communication terminal (mobile phone) of the present invention.

FIG. 7A is a schematic side view diagram showing an example of the position of the antenna mounting portion relative to the metallic member in the open state of the mobile communication terminal (mobile phone) of the present invention provided with the conductive element.

FIG. 7B is a schematic side view diagram showing an example of the position of the antenna mounting portion relative to the metallic member in the closed state of the mobile communication terminal (mobile phone) of the present invention provided with the conductive element.

FIG. 8 shows impedance characteristics in the open and closed states of the mobile communication terminal (mobile phone) of the present invention provided with the conductive element on a same graph.

FIG. 9 is a schematic diagram showing the interface portion between the upper and lower housing sections provided with the antenna and the conductive element in the open state of the mobile communication terminal (mobile phone) of the present invention.

FIG. 10 shows impedance characteristics in the open and closed states of the mobile communication terminal (mobile phone) of the present invention provided with the conductive element close to a feed point of the antenna on a same graph.

FIG. 11 is a schematic diagram showing the interface portion between the upper and lower housing sections provided with the antenna and the conductive element in the open state of the mobile communication terminal (mobile phone) of the present invention.

FIG. 12 is a table showing a relationship between an element width of the conductive element provided to the mobile communication terminal (mobile phone) of the present invention and a gap of resonant frequencies.

FIG. 13A is a schematic side view diagram showing an example of a position of an antenna mounting portion relative to a metallic member in an open state of the mobile communication terminal (mobile phone) of the present invention.

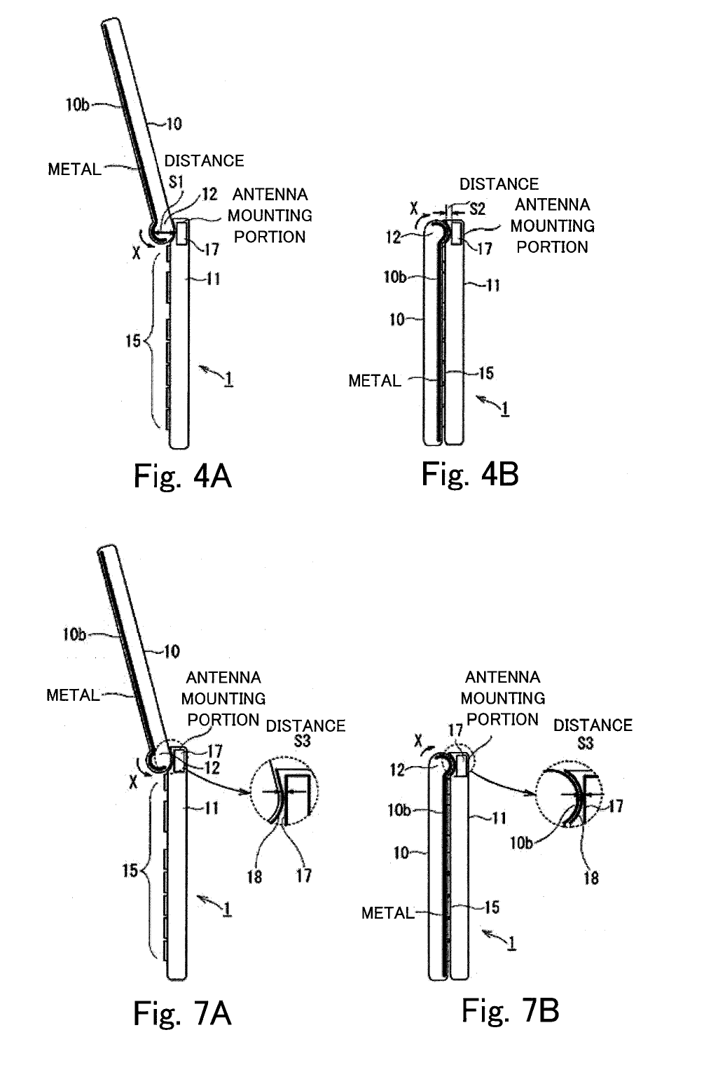

FIG. 4B is a schematic side view diagram showing an example of a position of the antenna mounting portion relative to the metallic member in a closed state of the mobile communication terminal (mobile phone) of the present invention.

### DETAILED DESCRIPTION OF THE INVENTION

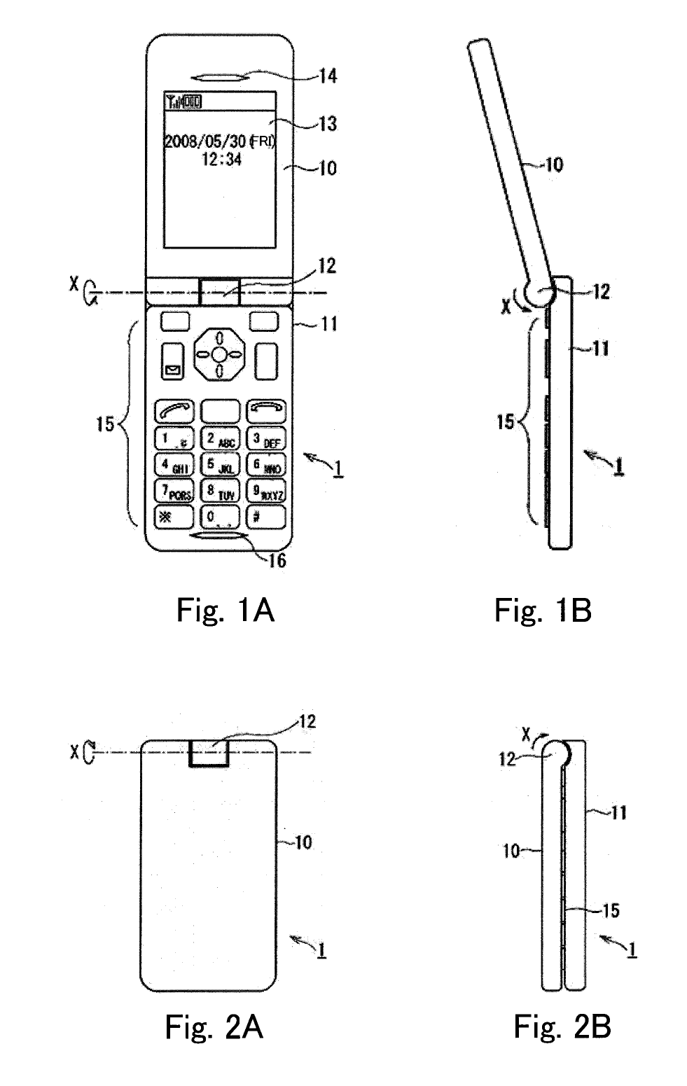

An embodiment of a mobile communication terminal of the present invention will be explained with reference to the drawings. A mobile phone 1 of a clamshell type constituted by plural housing sections movably coupled to each other around one axis will be illustrated as an example of the mobile communication terminal of the present invention. FIG. 1A is a front view of the mobile phone 1 being open. FIG. 1B is a side view of the mobile phone 1 being open. FIG. 2A is a front view of the mobile phone 1 being closed. FIG. 2B is a side view of the mobile phone 1 being closed.

As shown in FIGS. 1A-2B, the mobile phone 1 is constituted mainly by a rectangular plate-like upper housing section 10 and a lower housing section 11 having almost a same shape as the upper housing section 10. The upper housing section 10 and the lower housing section 11 are layered in the closed state in such a way that the one of them mutually covers a face of the other. The upper housing section 10 is provided with a hinge portion 12, and is hinge-coupled to the lower housing section 11 through the hinge portion 12. Then, the mobile phone 1 is configured in such a way that the upper housing section 10 can freely rotate in an X-direction shown in FIG. 1A within a certain angle range with respect to the lower housing section 11 around the hinge portion 12 as an axis. As the upper housing section 10 rotates with respect to the lower housing section 11, the mobile phone 1 changes from the closed state to the open state, or vice versa.

The upper housing section 10 has an internal face (a face on a side being opposite the lower housing section 11 in the closed state) provided with a display 13 for displaying data and a receiver 14 for receiving and outputting voice. The display 13 and the receiver 14 are not exposed to the outside as being covered by the lower housing section 11 in the closed state. If the upper housing section 10 rotates with respect to the lower housing section 11 so that the mobile phone 1 changes into the open state, the display 13 and the receiver 14 are exposed to the outside.

The lower housing section 11 has an internal face (a face on a side being opposite the upper housing section 10 in the closed state) provided with operation keys 15 for being pressed by a user for a data input operation. The operation keys 15 include, e.g., a 4-way navigation key for moving a cursor or displayed content up, down, left and right, a selection key for selecting an item, a ten key for entering numerals or character strings, a call key for making a call request and so on. The internal face of the lower housing section 11 is provided with a microphone 16 for collecting voice. The operation keys 15 and the microphone 16 are not exposed to the outside as being covered by the upper housing section 10 in the closed state. If the upper housing section 10 rotates with respect to the lower housing section 11 so that the mobile phone 1 changes into the open state, the operation keys 15 and the microphone 16 are exposed to the outside.

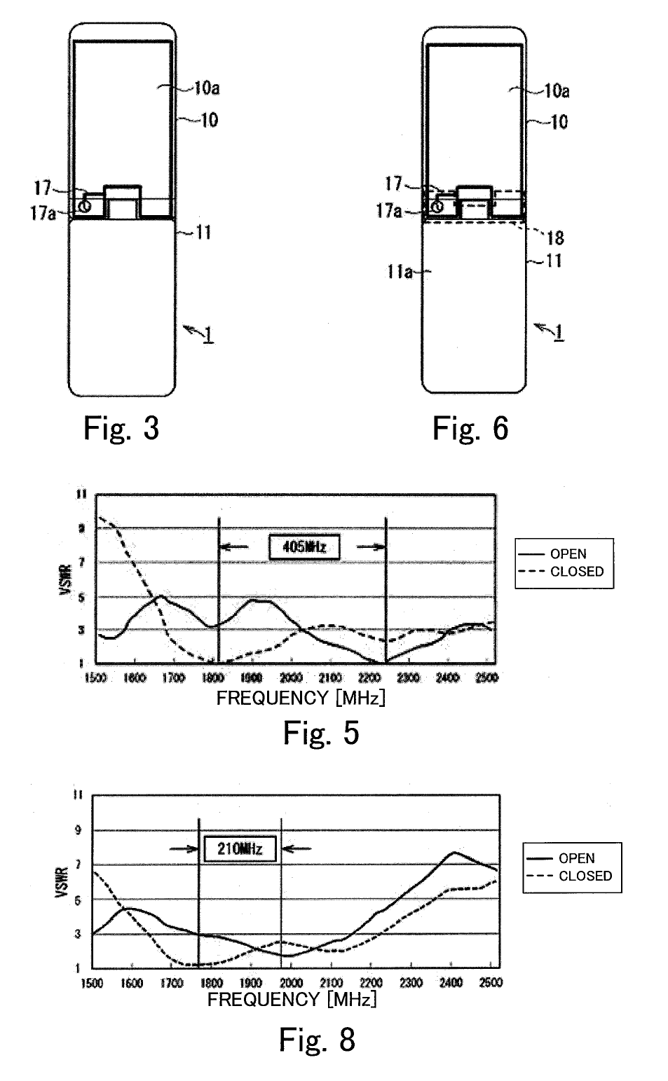

FIG. 3 is a schematic diagram showing an antenna 17 provided in an interface portion between the upper housing section 10 and the lower housing section 11 in the open state of the mobile phone 1. As shown in FIG. 3, the mobile phone 1 has, e.g., an internal case 10a of the upper housing section 10 formed by metallic material such as magnesium, or is provided with a metallic member 10b in the internal case 10a of the upper housing section 10. A growing trend in such a mobile phone changeably formed by these plural housing sections in recent years is to have an internal case of the housing section formed by metal such as magnesium from a viewpoint of mechanical strength of a display or from an aesthetic viewpoint. Assume in a following explanation that the metallic member 10b is provided to the internal case 10a of the upper housing section 10.

Further, as shown in FIG. 3, a feed point 17a of the antenna 17 is provided in a portion of a printed board 11a of the lower housing section 11 being close to the hinge portion 12, and the antenna 17 is mounted as extending from the lower housing section 11 to the hinge portion 12. The antenna 17 is, e.g., for a cellular communication use and, e.g., of a quarter-wavelength monopole type. If the metallic member 10b of the internal case 10a of the upper housing section 10 is arranged as overlapping the feed point 17a of the antenna 17 arranged in the lower housing section 11 and the antenna 17 mounted as extending from the lower housing section 11 to the hinge portion 12, distances between the feed point 17a and the metallic member 10b of the internal case and between the antenna 17 and the metallic member 10b of the internal case change depending upon whether the mobile phone 1 is in the open state or in the closed state.

FIG. 4A is a schematic side view diagram showing an example of a position of a mounting portion of the antenna 17 relative to the metallic member 10b in the open state of the mobile phone 1. FIG. 4B is a schematic side view diagram showing an example of a position of the mounting portion of the antenna 17 relative to the metallic member 10b in the closed state of the mobile phone 1. As the metallic member 10b is formed on the internal case 10a of the upper housing section 10 as shown in FIG. 4A, a distance S1 between the mounting portion of the antenna 17 and a portion of the metallic member 10b closest to the mounting portion of the antenna 17 in the open state of the mobile phone 1 approximately equals a thickness of the upper housing section 10. Meanwhile, a distance S2 between the mounting portion of the antenna 17 and, as shown in FIG. 4B, the portion of the metallic member 10b closest to the mounting portion of the antenna 17 in the closed state of the mobile phone 1 is smaller than the thickness of the upper housing section 10.

That is, the distance S1 between the antenna 17 and the metallic member 10b in the open state of the mobile phone 1 is greater than the distance S2 between the antenna 17 and the metallic member 10b in the closed state of the mobile phone 1. If the internal case 10a of the upper housing section 10 is provided with the metallic member 10b, the distance between the antenna 17 mounted as extending from the lower housing section 11 to the hinge portion 12 and the metallic member 10b of the upper housing section 10 changes depending upon whether the mobile phone 1 is in the open state or in the closed state, resulting in a significant change of an impedance characteristic of the antenna 17.

FIG. 5 shows impedance characteristics of the antenna 17 in the open and closed states of the mobile phone 1 on a same graph. The impedance characteristics are indicated on a horizontal and vertical axes representing a frequency and a VSWR (voltage standing wave ratio), respectively (omitted hereafter). As shown in FIG. 5, the VSWR of the antenna 17 is rendered minimum at a frequency of approximately 2215 MHz (resonant frequency) in the open state of the mobile phone 1. Further, the VSWR of the antenna 17 is rendered minimum at a frequency of approximately 1810 MHz (resonant frequency) in the closed state of the mobile phone 1. Thus, if the impedance characteristics of the antenna 17 in the open and closed states are compared with each other, a change of the resonant frequency caused by opening or closing the mobile phone 1 (a difference in the resonant frequencies in the open and closed states) is approximately 405 MHz.

In a case where the internal case 10a of the upper housing section 10 of the mobile phone 1 of a flip type is provided with the metallic member 10b and the antenna 17 is mounted close to the hinge portion 12 in the lower housing section 11, the antenna 17 is close to the metallic member 10b and a change in the position of the internal case 10a relative to the antenna 17 (such as the distance) causes a change of the resonant frequency of the antenna 17. If the difference in the impedance of the antenna 17 between the open state and the closed state is significant and the impedance of the antenna 17 is matched to the one of the open and closed states, a problem occurs in that antenna performance in the other state is rendered poor.

Thus, the internal case of the lower housing section 11 of the mobile phone 1 is loaded with a conductive element 18 that is not short-circuited to a grounded portion of the printed board 11a and is shaped to overlap the shape of the metallic member 10b of the internal case of the upper housing section 10 at a position where the antenna 17 is isolated from the metallic member 10b, so that a distance between the antenna 17 and the metallic component (conductor) arranged closest to the antenna 17 is kept constant. The change of the resonant frequency caused by opening and closing the mobile phone 1 can thereby be reduced.

FIG. 6 is a schematic diagram showing the interface portion between the upper housing section 10 and the lower housing section 11 in the open state of the mobile phone 1. The internal case 11b of the lower housing section 11 of the mobile phone 1 is loaded with the conductive element 18 shaped in accordance with the metallic member 10b provided in the internal case 10a of the upper housing section 10 as shown in FIG. 6, so that the change of the resonant frequency caused by opening and closing the mobile phone 1 can be reduced. Incidentally, the conductive element 18 is not short-circuited to the grounded portion of the printed board 11a, or else.

FIG. 7A is a schematic side view diagram showing an example of the position of the mounting portion of the antenna 17 relative to the metallic member 10b and the conductive element 18 in the open state of the mobile phone 1. FIG. 7B is a schematic side view diagram showing an example of the position of the mounting portion of the antenna 17 relative to the metallic member 10b and the conductive element 18 in the closed state of the mobile phone 1. As the internal case 11b of the lower housing section 11 is provided with the conductive element 18 as shown in FIGS. 7A and 7B, the conductive element 18 provided in the internal case 11b of the lower housing section 11 is the metallic component (conductor) arranged closest to the mounting portion of the antenna 17 mounted as extending from the lower housing section 11 to the hinge portion 12 is arranged both in the open and closed states of the mobile phone 1, and a distance S3 from the mounting portion of the antenna 17 to the metallic component arranged closest to the mounting portion of the antenna 17 (i.e., the conductive element 18) is rendered constant.

That is, both the distances between the antenna 17 and the metallic component arranged closest to the antenna 17 (i.e., the conductive element 18) in the open and closed states of the mobile phone 1 are the distance S3 and are approximately equal to each other. Thus, if the internal case 11b of the lower housing section 11 is provided with the conductive element 18, the conductive element 18 is always the metallic component (conductor) arranged closest to the antenna 17. As the distance between the antenna 17 mounted as extending from the lower housing section 11 to the hinge portion 12 and the conductive element 18 provided in the lower housing section 11 hardly changes both in the open and closed states of the mobile phone 1, the change of the impedance characteristic of the antenna 17 can be suppressed to a small level.

FIG. 8 shows impedance characteristics of the antenna 17 on a same graph in the open and closed states of the mobile phone 1 for which the lower housing section 11 is provided with the conductive element 18.

As shown in FIG. 8, the VSWR (voltage standing wave ratio) of the antenna 17 is rendered minimum at a frequency of approximately 1985 MHz (resonant frequency) in the open state of the mobile phone 1. Further, the VSWR (voltage standing wave ratio) of the antenna 17 is rendered minimum at a frequency of approximately 1775 MHz (resonant frequency) in the closed state of the mobile phone 1. Thus, if the impedance characteristics of the antenna 17 in the open and closed states are compared with each other, a change of the resonant frequency caused by opening or closing the mobile phone 1 is approximately 210 MHz. The change of the resonant frequency is 405 MHz, as described above, and 210 MHz without and with being loaded with the conductive element 18, respectively. It is known that the configuration loaded with the conductive element 18 contributes to reducing the change of the resonant frequency of the antenna 17 up to approximately 50 percent of the bandwidth.

In a case where the lower housing section 11 lacks a space to accommodate the conductive element 18 or a in case where manufacturing cost should be reduced for loading the mobile phone 1 with the conductive element 18, load only a portion of the antenna 17 close to the feed point 17a with the conductive element 18 so as to obtain a similar effect. In this case, load the internal case 11b of the lower housing section 11 with the conductive element 18 that is not short-circuited to the grounded portion of the printed board 11a and is shaped to cover the whole feed point 17a in the closed state of the mobile phone 1 and to overlap the shape of the metallic member 10b of the internal case 10a of the upper housing section 10 at a position where the antenna 17 is isolated from the metallic member 10b, so that the distance between the feed point 17a of the antenna 17 and the metallic component (conductor) arranged closest to the feed point 17a of the antenna 17 is kept constant. The change of the resonant frequency of the antenna 17 caused by opening and closing the mobile phone 1 can thereby be reduced.

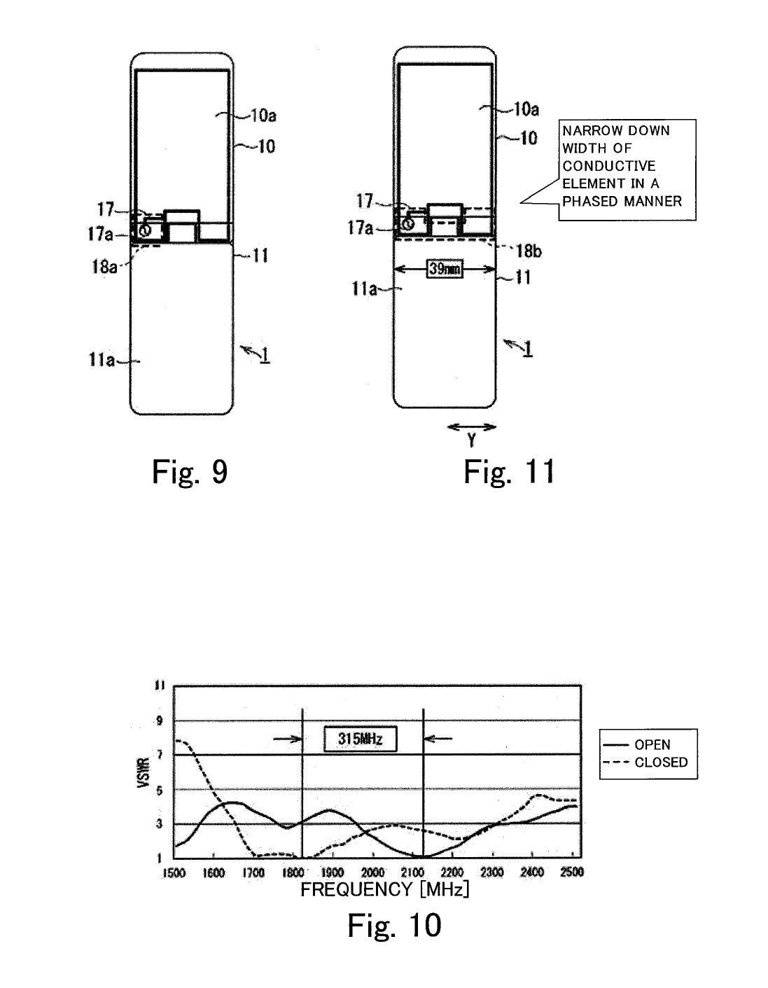

FIG. 9 is a schematic diagram showing the interface portion between the upper housing section 10 and the lower housing section 11 in the open state of the mobile phone 1 for which the internal case 11b of the lower housing section 11 is loaded with a conductive element 18a by which the feed point 17a of the antenna 17 provided on the printed board 11a of the lower housing section 11 is covered. As shown in FIG. 9, the internal case 11b of the lower housing section 11 of the mobile phone 1 on the side of the feed point 17a of the antenna 17 and the mounting portion of the antenna 17 is loaded with the conductive element 18a that is not short-circuited to the grounded portion of the printed board 11a, or else. Incidentally, the conductive element 18a is shaped in a smaller area than the conductive element 18 shown in FIG. 6.

FIG. 10 shows impedance characteristics of the antenna 17 on a same graph in the open and closed states of the mobile phone 1 for which the lower housing section 11 is provided with the conductive element 18a by which the feed point 17a of the antenna 17 of the upper housing section 10 is covered.

As shown in FIG. 10, the VSWR (voltage standing wave ratio) of the antenna 17 is rendered minimum at a frequency of approximately 2130 MHz (resonant frequency) in the open state of the mobile phone 1. Further, the VSWR (voltage standing wave ratio) of the antenna 17 is rendered minimum at a frequency of approximately 1815 MHz (resonant frequency) in the closed state of the mobile phone 1. Thus, if the impedance characteristics of the antenna 17 in the open and closed states are compared with each other, a change of the resonant frequency caused by opening or closing the mobile phone 1 is approximately 315 MHz. The change of the resonant frequency is 405 MHz, as described above, and 315 MHz without and with being loaded with the conductive element 18a, respectively. It is known that the configuration loaded with the conductive element 18a contributes to reducing the change of the resonant frequency of the antenna 17 up to approximately 20 percent of the bandwidth.

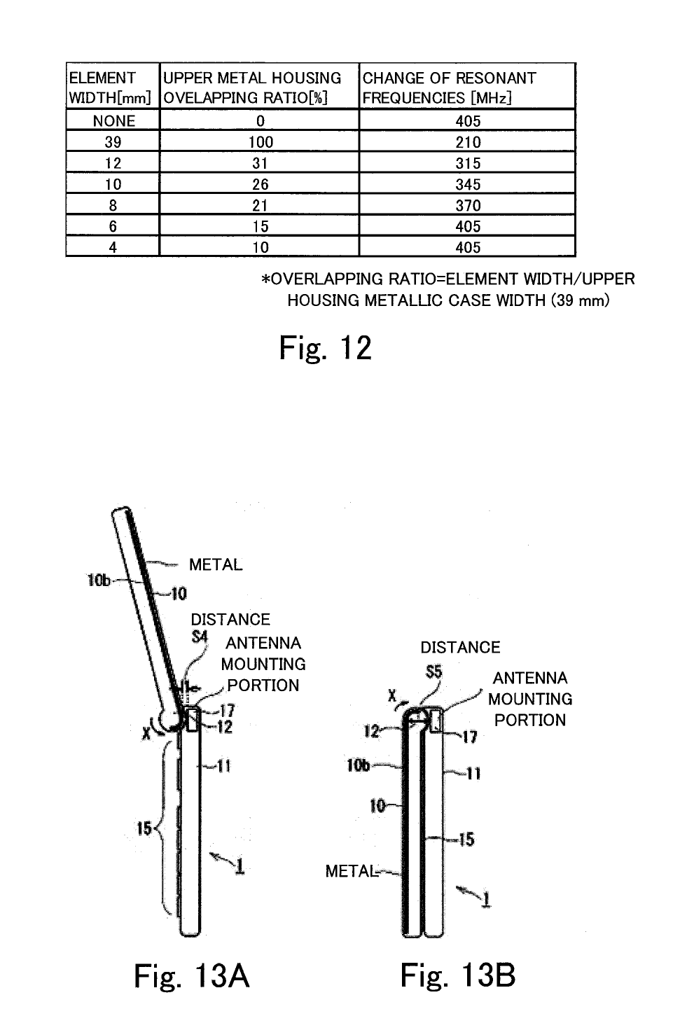

FIG. 11 is a schematic diagram showing the interface portion between the upper housing section 10 and the lower housing section 11 in the open state of the mobile phone 1 for which the internal case 11b of the lower housing section 11 is provided with a conductive element 18b. As shown in FIG. 11, the internal case 11b of the lower housing section 11 is provided with the conductive element 18b at a position where the antenna 17 is isolated from the metallic member 10b. FIG. 12 is a table showing a relationship between an element width of the conductive element 18b provided in the lower housing section 11 and a change of the resonant frequency of the antenna 17 in a case where the element width of the conductive element 18b is narrowed down from a maximum value equal to the width of the internal case 11b of the lower housing section 11 (e.g., 39 mm) in a direction of the width in a phased manner.

As shown in FIG. 12, the change of the resonant frequency without the use of the conductive element 18b is 405 MHz as described above, and the change of the resonant frequency is 210 MHz in a case where the lower housing section 11 is provided with the conductive element 18b as wide as 39 mm, i.e., the width of the internal case 11b of the lower housing section 11 (an overlapping ratio of 100 percent with the metallic member 10b of the upper housing section 10) as described above. The configuration provided with the conductive element 18b contributes to reducing the change of the resonant frequency of the antenna 17 up to approximately 50 percent of the change without loading the conductive element 18b.

Similarly, the change of the resonant frequency is 315 MHz in a case where the lower housing section 11 is provided with the conductive element 18b as wide as 12 mm (an overlapping ratio of 31 percent with the metallic member 10b of the upper housing section 10) as described above. The configuration provided with the conductive element 18b contributes to reducing the change of the resonant frequency of the antenna 17 by approximately 20 percent of the change without loading the conductive element 18b.

Similarly, the change of the resonant frequency is 345 MHz in a case where the lower housing section 11 is provided with the conductive element 18b as wide as 10 mm (an overlapping ratio of 26 percent with the metallic member 10b of the upper housing section 10). The change of the resonant frequency is 370 MHz in a case where the lower housing section 11 is provided with the conductive element 18b as wide as 8 mm (an overlapping ratio of 21 percent with the metallic member 10b of the upper housing section 10). The change of the resonant frequency is 405 MHz in a case where the lower housing section 11 is provided with the conductive element 18b as wide as 6 mm (an overlapping ratio of 15 percent with the metallic member 10b of the upper housing section 10). The change of the resonant frequency is 405 MHz in a case where the lower housing section 11 is provided with the conductive element 18b as wide as 4 mm (an overlapping ratio of 10 percent with the metallic member 10b of the upper housing section 10).

The table shown in FIG. 12 shows that the change of the resonant frequency caused by opening or closing the mobile phone 1 is reduced in comparison with the change without loading the conductive element 18b if the internal case 11b of the lower housing section 11 is provided with the conductive element 18b for which the overlapping ratio with the metallic member 10b of the upper housing section 10 is more than 15 percent.

According to the embodiment explained above, the metallic member 10b provided in the internal case 10a of the upper housing section 10 is formed by magnesium. The metallic member 10b is not limited to the above, and can be similarly formed by other optional metallic material. According to the embodiment explained above, the antenna 17 is a quarter-wavelength monopole antenna for a cellular communication use. The configuration of the present invention is not limited to the above, and can be applied to other antennas.

According to the embodiment explained above, the internal case 10a of the upper housing section 10 is provided with the metallic member 10b. The configuration of the present invention is not limited to the above, and can be applied to an arrangement such that an external case of the upper housing section 10 is provided with the metallic member 10b. FIG. 13A is a schematic side view diagram showing an example of a position of the mounting portion of the antenna 17 relative to the metallic member 10b in the open state of the mobile phone 1 for which the external case of the upper housing section 10 is provided with the metallic member 10b. FIG. 13B is a schematic side view diagram showing an example of a position of the mounting portion of the antenna 17 relative to the metallic member 10b in the closed state of the mobile phone 1 for which the external case of the upper housing section 10 is provided with the metallic member 10b.

As the metallic member 10b is formed on the external case of the upper housing section 10 as shown in FIG. 13B, a distance S5 between the mounting portion of the antenna 17 and a portion of the metallic member 10b closest to the mounting portion of the antenna 17 in the closed state of the mobile phone 1 approximately equals a thickness of the upper housing section 10. Meanwhile, a distance S4 between the mounting portion of the antenna 17 and the portion of the metallic member 10b closest to the mounting portion of the antenna 17 in the open state of the mobile phone 1 as shown in FIG. 13A is smaller than the thickness of the upper housing section 10.

That is, the distance S4 between the antenna 17 and the metallic member 10b in the open state of the mobile phone 1 is smaller than the distance S5 between the antenna 17 and the metallic member 10b in the closed state of the mobile phone 1. As the internal case 11b of the lower housing section 11 is provided with the conductive element 18b also in this case, the conductive element 18b is always the metallic component (conductor) arranged closest to the antenna 17, so that the distance between the antenna 17 and the metallic component arranged closest to the antenna 17 (i.e., the conductive element 18b) can be kept almost constant.

Further, the shape of the metallic member 10b of the internal case 11b (or the external case) of the upper housing section 11 is not limited to the shape explained with respect to the embodiment, and the configuration of the present invention can be applied to any shape of the metallic member 10b. That is, the conductive element 18b can be loaded in accordance with the shape of the metallic member 10b so that a similar effect is obtained regardless of the shape of the metallic member 10b.

According to the embodiment explained above, the feed point 17a of the antenna 17 is provided close to the hinge portion 12 of the upper housing section 10. The configuration of the present invention is not limited to the above, and can be applied no matter where the feed point 17a of the antenna 17 is provided.

According to the embodiment explained above, the internal case 11b of the lower housing section 11 is provided with the conductive element 18, 18a or 18b. The configuration of the present invention is not limited to the above, and can be such that the internal case 11b itself is formed by metallic material.

According to the embodiment explained above, the mobile phone 1 of the flip type is taken as an example. The configuration of the present invention is not limited to the above, and can be applied to any mobile phone that can be deformed into a plurality of shapes for which the distance between the antenna 17 and a metallic component (conductor) arranged closest to the antenna 17 changes depending upon the shape, such as a mobile phone of a two-axis rotating swivel type.

Even if being deformed into a plurality of shapes (e.g., open and closed states) and being provided with something metallic close to the antenna 17, the mobile communication terminal of the present invention (mobile phone 1) can reduce an impedance change of the antenna 17 caused by the change of the shape so that an antenna configuration more resisting metallic conditions can be implemented.

A growing trend in a mobile phone of a flip type is to have the internal case 10a of the upper housing section 10 formed by metallic material from a viewpoint of mechanical strength of a display or from an aesthetic viewpoint. The internal case 11b of the lower housing section 11 can be loaded, however, with the conductive element 18 (of an ungrounded type) and shaped to overlap the shape of the metallic member 10b of the internal case 10a of the upper housing section 10, so that the change of the resonant frequency caused by opening and closing the housing sections can be reduced much more than that in case without loading the conductive element 18. Further, even if being loaded into a position close to the feed point 17a and the antenna 17, the conductive element 18 of the ungrounded type can improve an impedance characteristic of the antenna 17 without degrading antenna characteristics such as an antenna gain.

The present invention has been explained as to the mobile phone 1. The mobile communication terminal of the present invention is not limited to the above, and can be any mobile terminal such as a PHS (Personal Handyphone System) phone, a PDA (Personal Digital Assistant), a portable game machine, a portable music player, a portable TV and so on as long as it can be deformed into a plurality of shapes and has the antenna 17.

The particular hardware or software implementation of the present invention may be varied while still remaining within the scope of the present invention. It is therefore to be understood that within the scope of the appended claims and their equivalents, the invention may be practiced otherwise than as specifically described herein.

What is claimed is:

1. A mobile communication terminal, comprising:
a first housing section including a metallic portion; and
a second housing section movably coupled to the first housing section, the second housing section being provided with an antenna, the second housing section being provided with a conductive element which covers a portion of the antenna from the metallic portion regardless of a position of the second housing section relative to the first housing section, the conductive element being electrically open.

2. The mobile communication terminal according to claim 1 further comprising a hinge portion, wherein
the second housing section is coupled to the first housing section through the hinge portion.

3. The mobile communication terminal according to claim 1, wherein the conductive element is shaped to overlap a portion of the metallic portion upon the metallic portion being positioned closest to the antenna.

4. The mobile communication terminal according to claim 1, wherein the portion of the antenna covered from the metallic portion by the conductive element includes a feed point of the antenna.

5. The mobile communication terminal according to claim 1, wherein the conductive element is provided so as to occupy more than 15 percent of an area of the metallic portion as viewed from the portion of the antenna covered from the metallic portion by the conductive element.

6. The mobile communication terminal according to claim 1, wherein the first housing section is constituted by including a case formed by a metallic material as the metallic portion.

7. The mobile communication terminal according to claim 1, wherein the first housing section includes a metallic member as the metallic portion.

8. A mobile communication terminal which can be deformed into a plurality of shapes including a first shape and a second shape, comprising:
an antenna; and
a conductive element provided at a position which is equally distant from the antenna upon the mobile communication terminal being in the first shape and in the second shape, the conductive element being a conductor arranged closest to the antenna at the position regardless of which of the first shape and the second shape the mobile communication terminal is in.

9. The mobile communication terminal according to claim 8 further comprising a first housing section and a second housing section, wherein
the mobile communication terminal is constituted by the first housing section and the second housing section hinge-coupled to each other, the mobile communication terminal being deformed into the first shape and the second shape as the first housing section changes a position relative to the second housing section,
the first housing section is provided with a metallic member,
the second housing section is provided with the antenna, and
the conductive element is provided at a position in the second housing section where the conductive element covers the antenna from the metallic member.

10. The mobile communication terminal according to claim 9, wherein the conductive element is shaped into a shape which covers the whole antenna, the conductive element being provided at the position where the conductive element covers the antenna from the metallic member regardless of which of the first shape and the second shape the mobile communication terminal is in.

11. The mobile communication terminal according to claim 9, wherein the conductive element is shaped into a shape which covers a feed point of the antenna, the conductive element being provided at the position where the conductive element covers the antenna from the metallic member regardless of which of the first shape and the second shape the mobile communication terminal is in.

12. The mobile communication terminal according to claim 9, wherein the conductive element is shaped into a shape which covers a feed point of the antenna, the conductive element being provided at the position where the conductive element covers the antenna from the metallic member regardless of in which of the first shape and the second shape the mobile communication terminal is in such a way that an overlapping ratio with the metallic member provided to the first housing section is equal to or more than 15 percent.
